(19) United States
(12) Patent Application Publication
(10) Pub. No.: US 2016/0370471 A1
(43) Pub. Date: Dec. 22, 2016

(54) ON-BOARD UNIT AND SPOOFING DETECTING METHOD

(71) Applicant: MITSUBISHI HEAVY INDUSTRIES, LTD., Tokyo (JP)

(72) Inventors: Yoshihiro MABUCHI, Tokyo (JP); Masato IEHARA, Tokyo (JP); Kenji FUJITA, Tokyo (JP); Taizo YAMAGUCHI, Tokyo (JP)

(21) Appl. No.: 14/901,803

(22) PCT Filed: Jul. 2, 2014
(86) PCT No.: PCT/JP2014/067622

§ 371 Date: Dec. 29, 2015

(30) Foreign Application Priority Data
Jul. 3, 2013 (JP) 2013-140000

(51) Int. Cl. G01S 19/21

(52) U.S. Cl. CPC G01S 19/215

(57) ABSTRACT

An on-board unit is provided with a positioning section and a processing section. The positioning section is configured to output a first position data showing a current position of a vehicle based on a positioning signal received from an artificial satellite. The processing section is configured to acquire second position data showing a current position of the vehicle based on a radio signal which is different from the positioning signal, and to detect a spoofing based on a position shown by the first position data and a position shown by the second position data.

### TECHNICAL FIELD

The present invention relates to an on-board unit that uses GNSS (Global Navigation Satellite System).

### BACKGROUND ART

A satellite positioning system is used that estimates the position of a vehicle and so on on the ground by using signals generated from artificial satellites. As such a technique, GNSS (Global Navigation Satellite Systems) such as GPS (Global Positioning System), GLONASS, and Galileo system are known.

By using the satellite positioning system, for example, charging processing to the vehicle which runs an area set as a toll highway can be carried out based on the positioning result of the vehicle by the artificial satellites.

### CITATION LIST

[Patent Literature 1]: JP 2008-510138A
[Patent Literature 2]: Singaporean Patent Publication No. 171571A

### SUMMARY OF THE INVENTION

In the satellite positioning system, a technique called a spoofing is known in which the estimated position is made to be mistaken as a position different from an actual position by camouflaging positioning signals transmitted from the artificial satellites. A technique is demanded that makes it possible to detect the spoofing, in order to carry out the charging process to the vehicle on the toll highway properly. Patent Literatures 1 and 2 are examples of the technique to cope with the spoofing.

In one aspect of the present invention, an on-board unit includes a positioning section configured to output a first position data showing a current position of a vehicle based on a positioning signal received from an artificial satellite; and a processing section configured to acquire a second position data showing a current position of the vehicle based on a radio signal which is different from the positioning signal, and to detect a spoofing based on a position shown by the first position data and a position shown by the second position data.

In an aspect of the present invention, a spoofing detecting method of an on-board unit includes: outputting first position data showing a current position of a vehicle based on a positioning signal received from an artificial satellite; acquiring second position data showing a current position of the vehicle by a radio signal which is different from the positioning signal; and detecting a spoofing based on the position shown in the first position data and the position shown in the second position data.

According to the present invention, the technique is provided that makes the detection of the spoofing possible.

### BRIEF DESCRIPTION OF THE DRAWINGS

FIG. 1 is a diagram showing a configuration of a satellite positioning system.

FIG. 2 is a diagram showing a configuration of an on-board unit.

FIG. 3 is a diagram showing a configuration of a spoofing detecting section.

FIG. 4 is a diagram showing an operation of the on-board unit.

FIG. 5 is a diagram showing a configuration of the satellite positioning system.

FIG. 6 is a diagram showing a configuration of the on-board unit.

FIG. 7 is a diagram showing a base station ID table.

FIG. 8 is a diagram showing an operation of the on-board unit.

FIG. 9 is a diagram showing a configuration of the satellite positioning system.

FIG. 10 is a diagram showing a configuration of the on-board unit.

FIG. 11 is a diagram showing a configuration of the spoofing detecting section.

FIG. 12 is a diagram showing an operation of the on-board unit.

FIG. 13 is a diagram showing an operation of the on-board unit.

FIG. 14 is a diagram showing an operation of the on-board unit.

### DESCRIPTION OF THE EMBODIMENTS

### First Embodiment

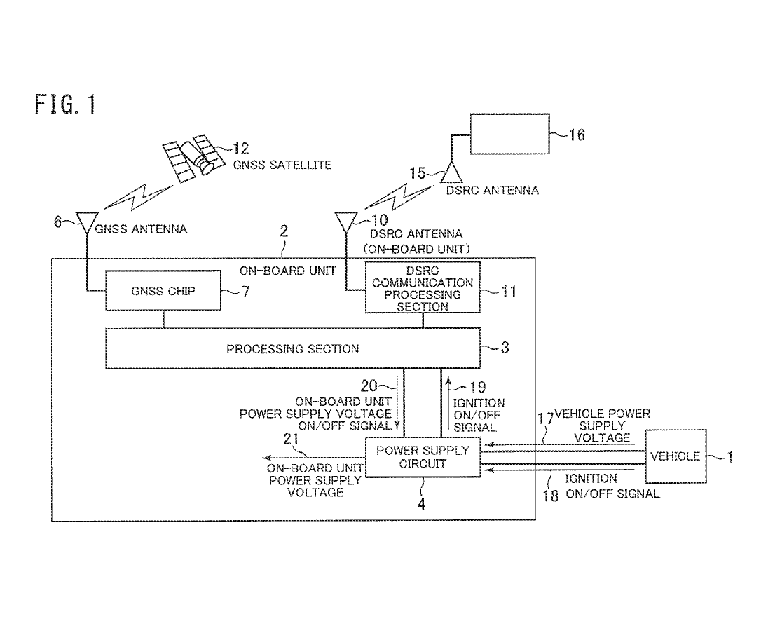

Hereinafter, embodiments of the present invention will be described with reference to the attached drawings. FIG. 1 shows a configuration of a satellite positioning system according to a first embodiment of the present invention. In the satellite positioning system, a position of a vehicle 1 is estimated based on GNSS satellite information carried with positioning signals transmitted from a plurality of GNSS satellites 12 (only one is illustrated). An on-board unit 2 is loaded onto a vehicle 1 of a user. The on-board unit 2 receives the GNSS satellite information by a GNSS antenna 6. A GNSS chip 7 provided in the on-board unit 2 estimates a current position of the vehicle 1 based on the received GNSS satellite information, and outputs the estimated current position as a positioning result. The on-board unit 2 further has a processing section 3 as a computer that carries out charging processing and so on by using the positioning result outputted from the GNSS chip 7.

The vehicle 1 has a battery, and supplies a vehicle power supply voltage 17 from the battery to the on-board unit 2. The vehicle power supply voltage 17 is supplied to a power supply circuit 4 of the on-board unit 2. The vehicle 1 further outputs an ignition ON/OFF signal 18 to the on-board unit 2 to show whether an ignition key has been rotated to an ON direction to turn on an engine or to an OFF direction to turn off the engine. The ignition ON/OFF signal 18 is transmitted to the processing section 3 as an ignition ON/OFF signal 19 via the power supply circuit 4.

The processing section 3 outputs an on-board unit power supply voltage ON/OFF signal 20 to the power supply circuit 4 according to the ignition ON/OFF signal 19 indicating that the ignition of the vehicle 1 has been turned on, to instruct the power supply circuit 4 of the on-board unit 2 to be turned on. The power supply circuit 4 outputs an on-board unit power supply voltage 21 based on the vehicle power supply voltage 17 supplied from the vehicle 1, in response to the on-board unit power supply voltage ON/OFF signal 20. Various circuits of the on-board unit 2 are driven with the on-board unit power supply voltage 21.

The on-board unit 2 further has a DSRC communication processing section 11 and a DSRC antenna 10. A roadside system 16 is installed in a roadside of a road through which the vehicle 1 runs and a parking lot. The roadside system 16 has a DSRC antenna 15. The roadside system 16 and the DSRC communication processing section 11 are possible to carry out DSRC (Dedicated Short Range Communication) bidirectionally through the DSRC antenna 15 and the DSRC antenna 10.

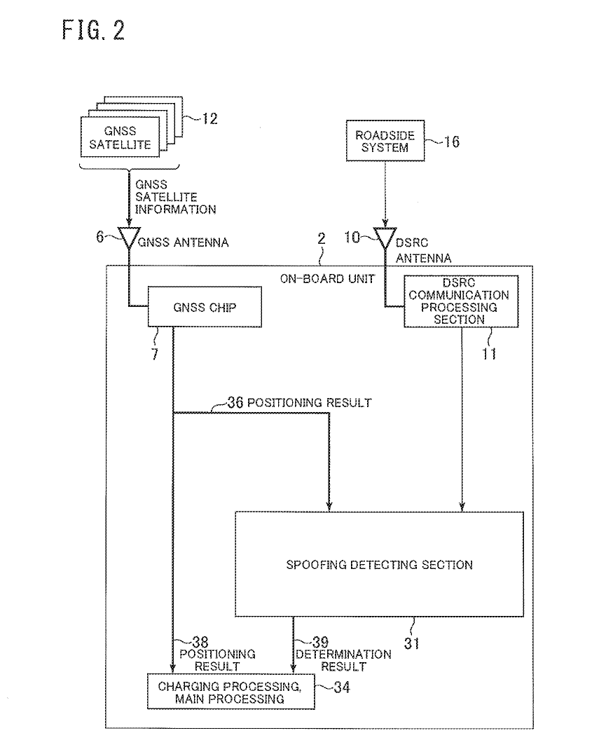

FIG. 2 shows a configuration of the on-board unit 2. The on-board unit 2 has the GNSS antenna 6, the GNSS chip 7, the DSRC antenna 10, the DSRC communication processing section 11, a main processing section 34 and a spoofing detecting section 31. Of them, the main processing section 34 and the spoofing detecting section 34 correspond to the processing section 3 of FIG. 1. Each of these sections which are contained in the processing section 3 may be realized in software by a CPU executing a program or in hardware by a separate unit having a corresponding function.

A positioning result 35 (first position data) outputted from the GNSS chip 7 is supplied to the spoofing detecting section 31. On the other hand, the roadside system 16 transmits DSRC position data (second position data) which shows a position of the DSRC antenna 15 (a roadside unit). The DSRC communication processing section 11 transfers the DSRC position data received by the DSRC antenna 10, to the spoofing detecting section 31 as a DSRC positioning result.

The spoofing detecting section 31 outputs a determination result 39 showing whether the spoofing has been carried out, based on the positioning result 36 outputted from the GNSS chip 7 (the GNSS positioning result) and the DSRC positioning data. The main processing section 34 executes the charging processing when the vehicle 1 runs on a toll highway based on the positioning result 38 outputted from the GNSS chip 7 and the determination result 39 outputted from the spoofing detecting section 31.

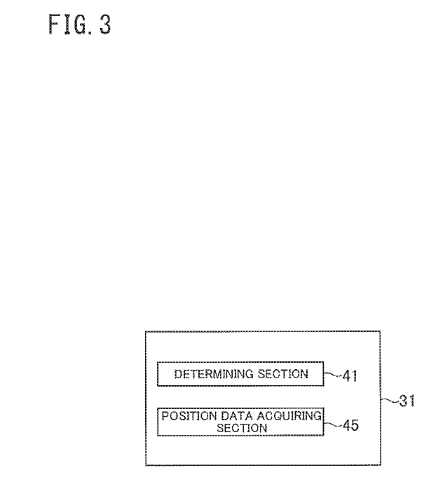

FIG. 3 shows functional blocks of the spoofing detecting section 31. The spoofing detecting section 31 in the present embodiment has a determining section 41 and a position data acquiring section 45. These functional blocks can be realized by a main CPU of the on-board unit 2 reading a program from a storage unit and operating according to a procedure described in the program.

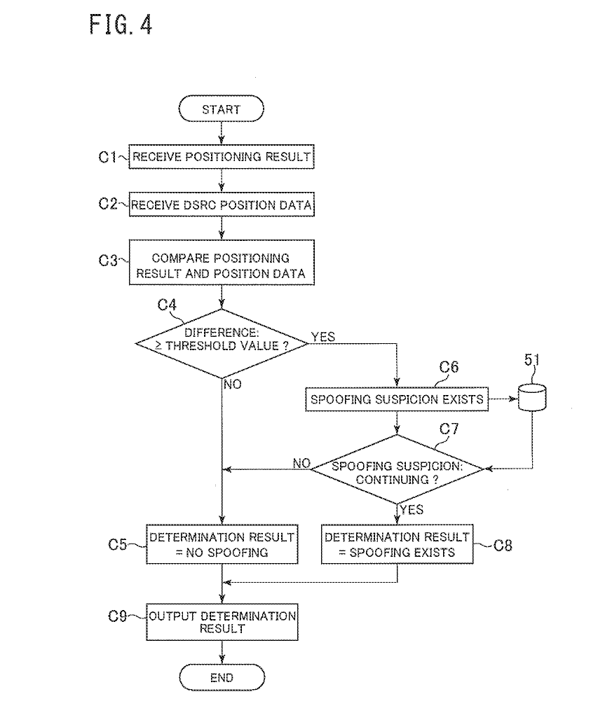

Next, an operation of the spoofing detecting section 31 of the present embodiment will be described with reference to FIG. 4. First, when the engine of the vehicle 1 is started up so that the on-board unit 2 is turned on, the GNSS chip 7 outputs the positioning results 36 and 38 which are data showing a three-dimensional position of the vehicle 1 on the ground, based on the GNSS satellite information (Step C1). The position data acquiring section 45 receives the DSRC position data from the DSRC communication processing section 11 in approximately realtime (Step C2).

The determining section 41 compares the current positioning result 36 outputted from the GNSS chip 7 (the GNSS positioning result) and the DSRC position data (Step C3). The determining section 41 compares a difference between a position by the GNSS positioning result and a position shown by the DSRC position data (a distance between both) and a preset threshold value. As the threshold value, a distance is set which is equal to or more than a distance corresponding to a communication area of the DSRC roadside unit. The determining section 41 advances to the processing of step C5 when the difference is smaller than the threshold value (step C4; NO), and advances to the processing of step C6 when the difference is equal to or more than the threshold value (step C4; YES).

When the determination of YES is accomplished at step C4, the determining section 41 determines that a spoofing suspicion exists (Step C6). When the spoofing suspicion is determined to exist, a record of spoofing suspicion is registered on a spoofing candidacy database 51 in relation to the current time.

The determining section 41 extracts a record of past spoofing suspicion from the spoofing candidacy database 51 when the spoofing suspicion is determined to exist. When a period for which the spoofing suspicion continues is shorter than a predetermined threshold value (Step C7; NO), the determining section 41 determines that the spoofing suspicion is a short-range positioning error due to a multipath and so on and any spoofing has not been carried out (Step C5). When the period is equal to or longer than the predetermined threshold value (Step C7; YES), the determining section 41 determines that the spoofing has been carried out (Step C8).

Through the processing of steps C6 to C8, an erroneous determination of execution of the spoofing can be avoided when a running route of the vehicle based on the satellite positioning shows a temporarily unusual change due to the multipath and so on and returns to an original correct positioning result again.

The determining section 41 outputs the determination result showing the non-existence of spoofing at step C5 or the existence of spoofing at step C8 (Step C9). The main processing section 34 takes the determination result 39 into consideration, when performing the charging processing and so on based on the positioning result 38 outputted from the GNSS chip 7. For example, when the spoofing is determined to have been carried out, the main processing section 34 stops the usual charging processing, and stores data showing the determination result 39 in the storage unit.

Through the above processing, the spoofing can be detected when the positioning result based on the GNSS satellite information is unnaturally apart from the position of the communicating DSRC roadside unit, as the result of the spoofing.

The spoofing detection by the above-described means has an advantage that the loading into the on-board unit 2 is easy. Below, the advantage will be described.

In the satellite positioning system, the exclusive-use GNSS chip is loaded into the on-board unit. In order to implement a spoofing detecting function, it could be considered that a function of verifying data received from the GNSS satellite is added to the GNSS chip. However, from the viewpoint of the easiness of implementing, a technique is demanded that makes it possible to carry out the spoofing detection by using a signal outputted from the GNSS chip without applying a change to the GNSS chip.

A standard of signals which the GNSS chip outputs is set by NMEA (National Marine Electronics Association) and so on. If the spoofing can be detected based on the output signal set according to such a standard, a type of chip to be adopted can be determined and the degrees of freedom of the chip selection is high.

In the spoofing detection processing shown in FIG. 4, the estimated position of the vehicle 1 outputted from the GNSS chip 7 is used as data generated by the satellite positioning system. It is set to the standard that any type of GNSS chip 7 can output such an estimated position. The detailed information which the GNSS chip 7 does not always output, such as orbit information of each GNSS satellite is not needed in the spoofing detection in FIG. 4. Therefore, there is an advantage that the spoofing detection processing shown in FIG. 4 can be executed without applying any change to the GNSS chip 7, and regardless of a type of GNSS chip 7. Embodiments of the present invention which is described below have such an advantage, in the same way.

### Second Embodiment

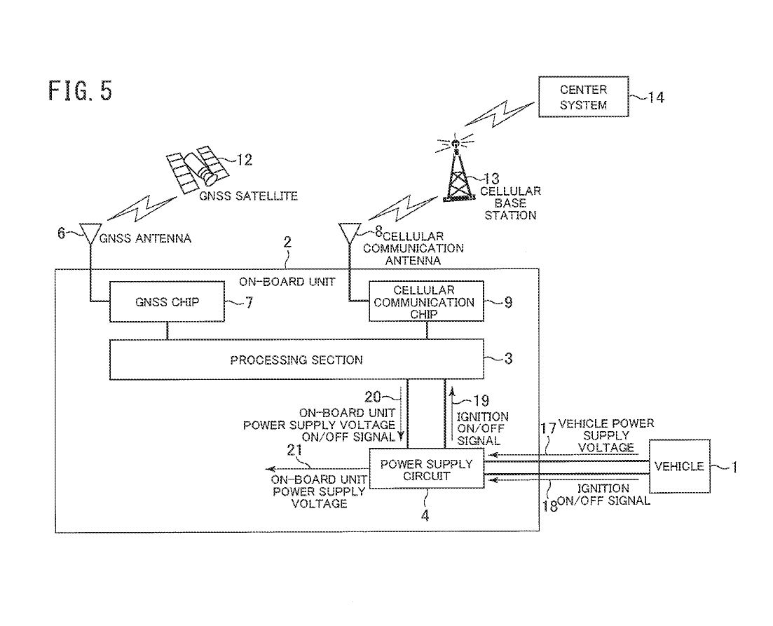

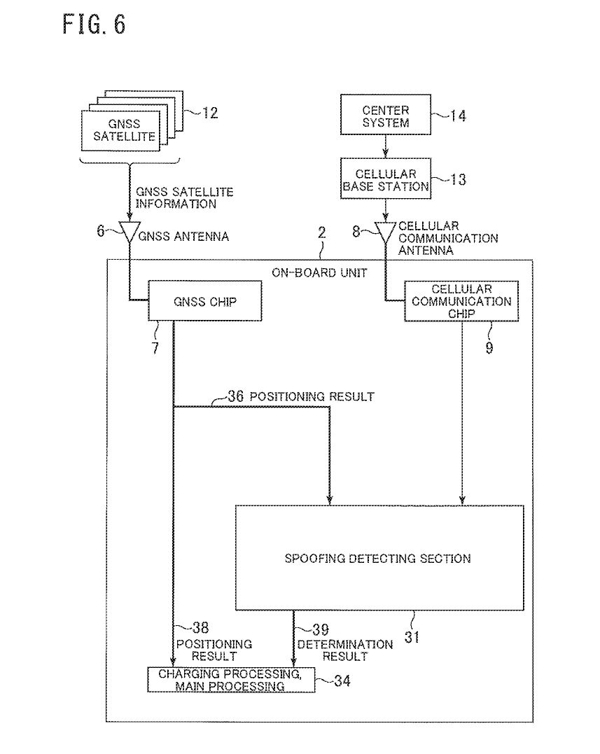

FIG. 5 shows a configuration of the satellite positioning system according to a second embodiment of the present invention. FIG. 6 shows a configuration of the on-board unit 2 of the present embodiment. In the present embodiment, a cellular communication is used in place of the roadside system 16 in the first embodiment. Compared with the satellite positioning system shown in FIG. 1, the satellite positioning system of the present embodiment has a cellular communication chip 9 and a cellular communication antenna 8, and uses a cellular communication network which includes a center system 14 and cellular base stations 13.

The cellular communication is a generally used method as one of methods of mobile communication. The outline of mobile communication will be described below. In the cellular communication, a communication area is divided into many small cells and a base station is installed in each cell. The size of one cell is in a range of several kilometers to ten and several kilometers, having the base station as a center, but the method of dividing into micro cells which are smaller than the cell may be used. The output power of the radio wave of each base station is an extent to cover a cell to which the base station belongs, as a communication area. That is, the base stations are installed apart from each other to an extent that radio wave interference to the other base stations is not caused. Therefore, the same frequency can be used in a different base station and it is possible to use the frequency effectively.

The cellular communication network can be used as a part of a charging system that uses a position estimation result of the vehicle 1 by GNSS. The GNSS chip 7 estimates the position of the vehicle 1 based on the GNSS satellite information received from the GNSS satellite 12 to output as the positioning result (position data). The cellular communication chip 9 transmits the positioning result from the cellular communication antenna 8. The positioning result is transmitted to a center system 14 through the cellular base station 13 near the vehicle 1. By carrying out a bidirectional communication between the on-board unit 2 and the cellular communication network, the charging processing using the positioning results of the vehicle 1 is carried out.

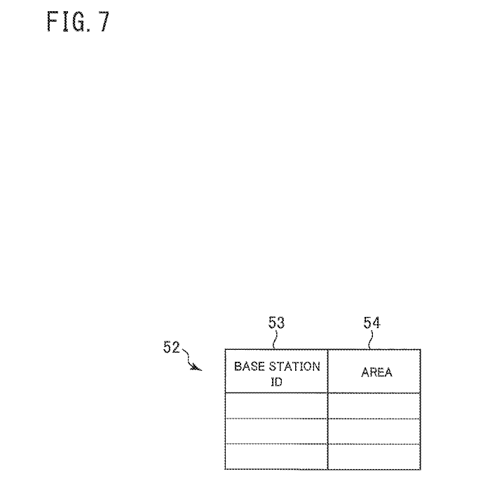

FIG. 7 shows a base station ID table 52 which has been previously registered on the spoofing detecting section 31 in the present embodiment. The base station ID table 52 relates a base station ID 53 which is an identifier for specifying each of a plurality of base stations and an area 54 which is data showing a communication range which is covered by each base station.

In the present embodiment, the spoofing detecting section 3 carries out a spoofing detection by using the position of the cellular base station 13 in place of the DSRC position data in case of an operation of the first embodiment shown in FIG. 4. The cellular communication network transmits to the on-board unit 2, a base station ID 53 which specifies the cellular base station 13 in the communication state with the on-board unit 2 in case to communicate with the on-board unit 2 through the cellular base station 13 for the charging processing and so on. The position of the vehicle 1 can be known roughly based on position of the base station ID 53, which can be used in place of the DSRC positioning result (position data) in the first embodiment.

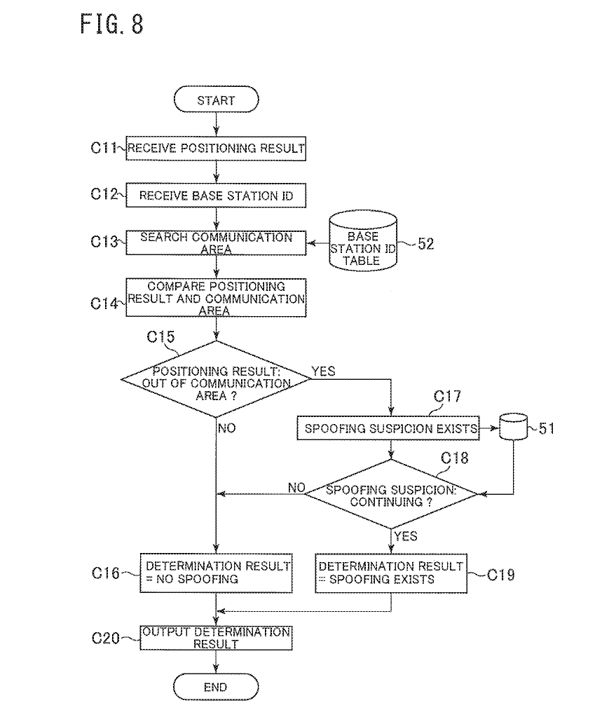

FIG. 8 shows an operation of the spoofing detecting section 31 in the present embodiment. Like step C1 of FIG. 4, the positioning result 36 by the satellite positioning system is supplied to the spoofing detecting section 31 (Step C11). The cellular communication chip 9 extracts the base station ID 53 which specifies the cellular base station 13 in the communication state, from among signals received from the cellular base station 13 through the cellular communication antenna 8. The position data acquiring section 45 receives the base station ID 53 from the cellular communication chip 9 (Step C12). The position data acquiring section 45 searches an area 54 corresponding to the base station ID 53 which has been acquired from the cellular communication chip 9, from the base station ID table 52 (Step C13).

The determining section 41 compares the position shown by the GNSS positioning result and the area 54 searched from the base station ID table 52 (a cellular base station communication area) (Step C14). The determining section 41 advances to the processing of step C16 when the GNSS positioning result is within the cellular base station communication area (Step C15; NO) and advances to the processing of step C17 when being not within the area (step C15; YES). The processing of steps C16 to C20 is the same as the processing of steps C5 to C9 of FIG. 4.

In the present embodiment, the spoofing detecting section 3 carries out the spoofing detection by using the position of the cellular base station 13 in the communication state in place of the DSRC positioning result in the first embodiment shown in FIG. 4. In such a satellite positioning system, the spoofing detection can be carried out in the area where any DSRC roadside unit is not installed.

### Third Embodiment

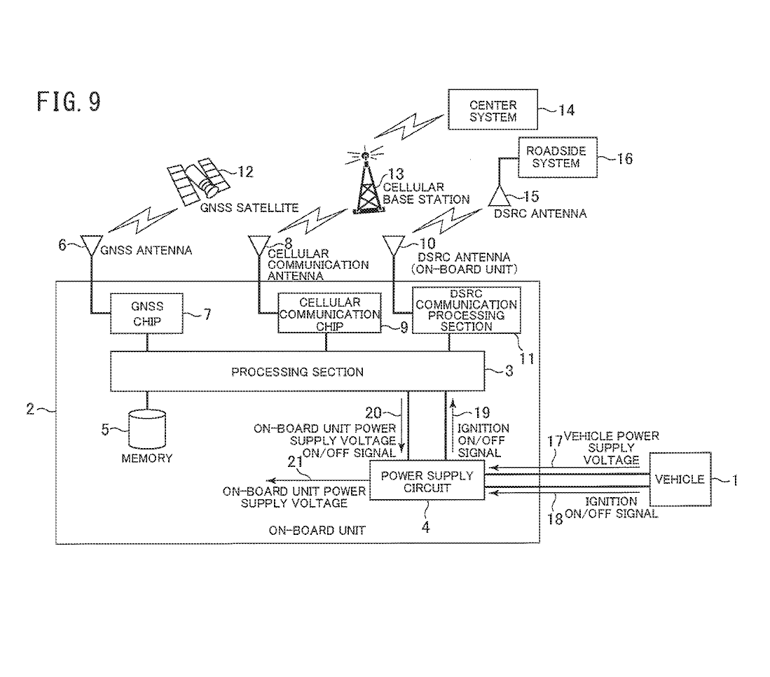

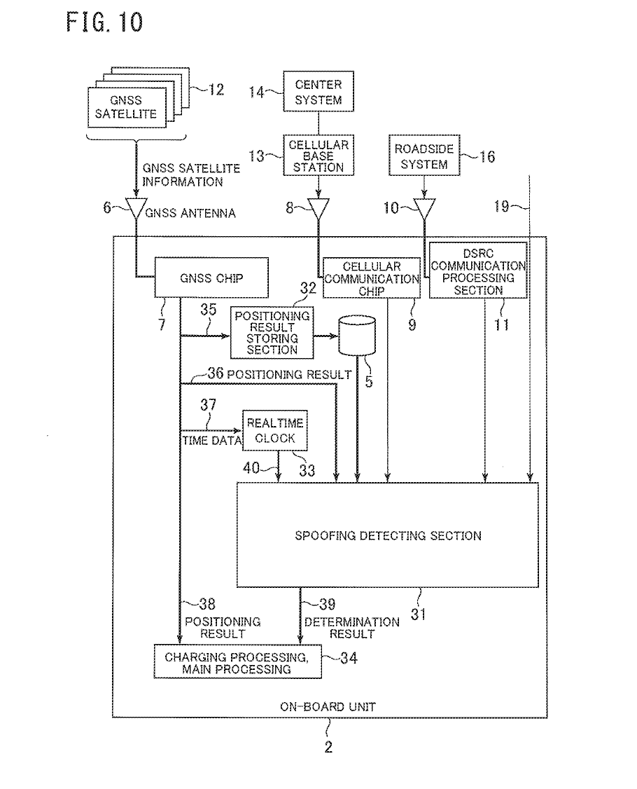

Next, a third embodiment of the present invention will be described. FIG. 9 shows a configuration of the satellite positioning system in the third embodiment. FIG. 10 shows a configuration of the on-board unit 2 in the present embodiment. In the present embodiment, the following processing is carried out:

(1) the spoofing detection based on past and current GNSS positioning results;

(2) the spoofing detection based on the comparison between GNSS time data and DSRO time data or the comparison between the GNSS time data and the cellular communication time data; and

(3) the spoofing detection based on the comparison of the GNSS positioning result and the position of the DSRC roadside unit or the comparison of the GNSS positioning result and the communication area of the cellular base station.

Of them, in case of (3), the processing shown in the first embodiment or the second embodiment is carried out. In the present embodiment, the processing of (1) and (2) is further added.

### (Record of Past Positioning Result)

In the on-board unit 2 of the present embodiment, the processing section 3 stores the positioning result based on the GNSS satellite information, in the positioning result storage area 5 of the storage unit, together with the positioning time showing a time when the positioning was carried out. When the GNSS chip 7 outputs the positioning result 35, the positioning result storing section 32 stores the positioning result 35 in the positioning result storage area 5 together with the current time. The positioning result 35 is stored in the positioning result storage area 5 in relation to the positioning time.

### (Acquisition of Time Data by DSRO)

As shown in FIG. 10, the on-board unit 2 of the present embodiment has a realtime clock 33. The GNSS time data 37 showing current time is contained in the data generated from the GNSS chip 7 based on the GNSS satellite information. The GNSS chip 7 outputs the GNSS time data 37 to the realtime clock 33 in the on-board unit 2. The realtime clock 33 outputs GNSS time data 40 in the form which can be used as a time stamp and so on in the processing in the on-board unit 2, in response to the GNSS time data 37 received from the GNSS chip 7. The GNSS time data 37 outputted from the GNSS chip 7 and the GNSS time data 40 outputted from the realtime clock 33 are different in the form but have substantively identical contents.

The roadside system 16 always generates the DSRC time data shows the current time. The DSRC communication processing section 11 receives the DSRC time data through the DSRC antenna 10 to transfer to the spoofing detecting section 31.

### (Configuration of Spoofing Detecting Section)

The spoofing detecting section 31 outputs a determination result 39 showing whether or not a spoofing has been carried out, based on the positioning time and the past positioning result 35 which were stored in the positioning result storage area 5, the positioning result 36 outputted from the GNSS chip 7 (the GNSS positioning result), the GNSS time data 40 outputted from the realtime clock 33, and the DSRC time data outputted from the DSRC communication processing section 11. The main processing section 34 carries out the charging processing when the vehicle 1 runs a toll highway, based on the positioning result 38 outputted from the GNSS chip 7, and the determination result 39 outputted from the spoofing detecting section 31.

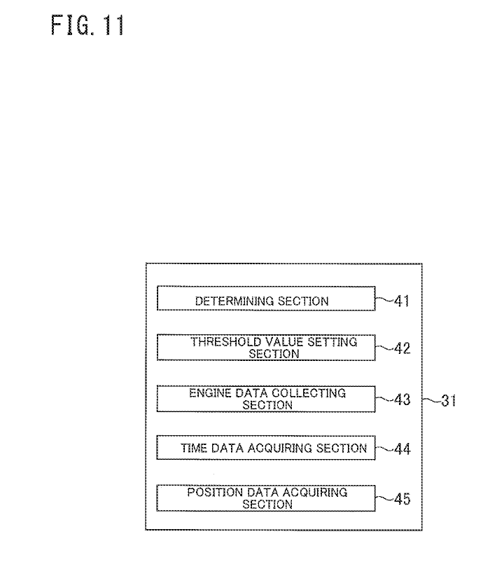

FIG. 11 shows functional blocks of the spoofing detecting section 31. The spoofing detecting section 31 in the present embodiment further has a threshold value setting section 42, an engine data collecting section 43 and a time data acquiring section 44 in addition to the first embodiment shown in FIG. 3. These functional blocks can be realized by a main CPU of the on-board unit 2 which reads a program stored in the storage unit and operates according to the procedure described in the program.

### (Operation of Spoofing Detecting Section by Using Past and Current GNSS Positioning Results)

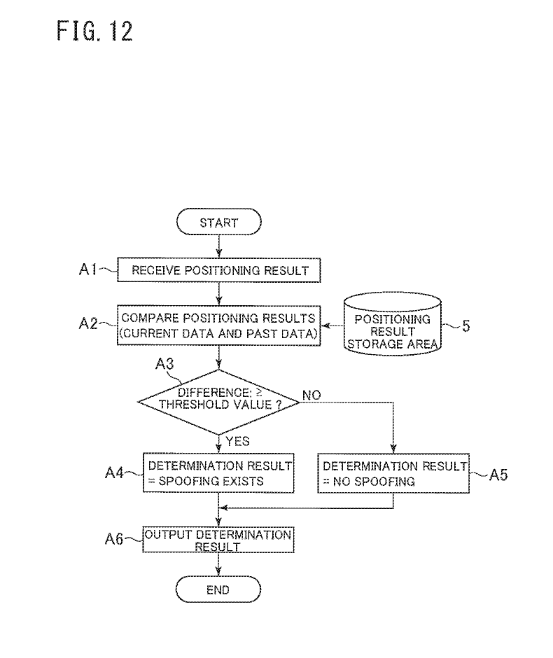

Next, an operation of the spoofing detecting section 31 in the present embodiment will be described. In the present embodiment, the spoofing detecting section 31 carries out the spoofing detection based on the past and current GNSS positioning results (the previously-mentioned processing (1)). FIG. 12 is a flow chart showing the operation of the spoofing detecting section 31 in case of the spoofing detection based on the past and current GNSS positioning results in the present embodiment.

When the engine of the vehicle 1 is started up to turn on the on-board unit 2, the GNSS chip 7 outputs the positioning results 35, 36, 38 as the data showing a three-dimensional position of the vehicle 1 on the ground based on the GNSS satellite information. The positioning result storing section 35 stores the positioning result 35 in the positioning result storage area 5 together with the positioning time showing the current time (Step A1).

The determining section 41 compares the current positioning result 36 outputted from the GNSS chip 7 and the past positioning result stored in the positioning result storage area 5. This comparison is carried out by, for example, presetting a time difference quantity, reading a past positioning result previous by the preset time difference quantity (e.g. 10 seconds before) from the positioning result storage area 5, and comparing with the current positioning result 36 (Step A2).

The determining section 41 compares a difference between the past positioning result and the current positioning result and a preset threshold value to determine which of them is more. As the threshold value, a distance is set that seems to be unnatural for the vehicle 1 to move for the preset time difference quantity used at step A2. For example, when the time difference quantity of 10 seconds is set and the distance of 500 meters is set as the threshold values, if a difference between the past positioning result before 10 seconds and the current positioning result is equal to or more than 500 meters, it is determined to be unnatural movement.

When the difference is less than the threshold value (Step A3; NO), the determining section 41 determines that there is no spoofing and the positioning is normally carried out (Step A5). When the difference is equal to or more than the threshold value (Step A3; YES), the spoofing is determined to have been carried out (Step A4).

The determining section 41 outputs the determination result 39 of the existence or non-existence of spoofing (Step A6). The main processing section 34 executes processing such as charging processing based on the positioning result 38, taking the determination result 39 into consideration. For example, when the spoofing is determined to have been carried out, usual charging processing is stopped and the data showing the determination result 39 is stored in the storage unit.

Through the above processing, when the positioning result based on the GNSS satellite information shows an unnatural large leap as the result of the spoofing, the charging processing depending on spoofing data can be avoided.

In addition to the above spoofing detection processing, means for distinguishing a positioning error in the satellite positioning system due to a multipath and so on may be provided. In case of the positioning error due to the multipath, for example, the running route of the vehicle based on the satellite positioning shows a temporarily unnatural leap but returns to an original correct positioning result again. Therefore, when a period for which the difference of the distance is determined to be equal to or the threshold value at step A3 is shorter than a given period, it may be determined that there is a possibility of the positioning error due to the multipath and so on, so that a spoofing may not be determined to have been carried out.

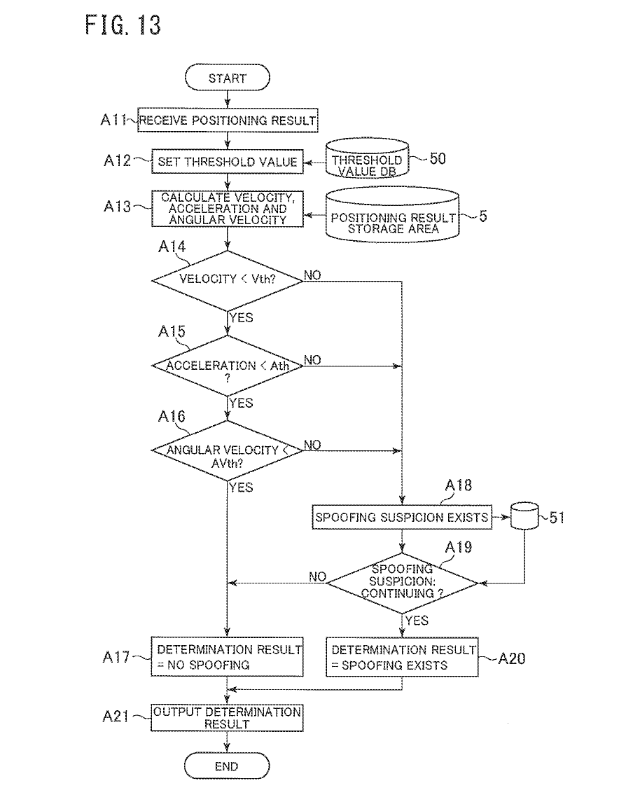

In addition to the above-mentioned processing shown in FIG. 12, moreover, the spoofing determining processing can be carried out by an operation of the threshold value setting section 42. FIG. 13 is a flow chart showing such an operation of the spoofing detecting section 31. The GNSS chip 7 outputs the positioning results 35, 36 and 38, like the step A1 of FIG. 12. The positioning result storing section 32 stores the positioning result 35 in the positioning result storage area 5 together with a positioning time showing the current time (Step A11).

Next, the threshold value setting section 42 refers to the threshold value database 50 stored in the storage unit of the on-board unit 2 and sets a threshold value. For example, the position change of the vehicle 1 is fast while the vehicle 1 runs on a highway, and the position change of the vehicle 1 is late while running in an urban area. Therefore, it is possible to determine whether a change on a time series of the positioning results 35, 36, and 38 of the vehicle 1 is unnatural, by setting a threshold value of the different running speed according to the current position of the vehicle 1.

To carry out such a determination, the threshold value database 50 stores an area on a map and a threshold value to relate the area with the threshold value. For example, a large threshold value of speed is set to the area showing a highway and a small threshold value of speed is set to the area showing an urban area. The threshold value setting section 42 extracts the threshold value corresponding to the current position of the vehicle 1 shown by the positioning result 36 outputted from the GNSS chip 7, from the threshold value database 50 and sets as a threshold value for the spoofing detection. For example, such a threshold value can be set to each of speed, acceleration, angular speed, and so on of the vehicle (Step A12).

The determining section 41 calculates the current speed, acceleration and angular speed of the vehicle 1 based on the positioning result 36 supplied from the GNSS chip 7 and a record of past positioning result and positioning time stored in the positioning result storage area 5 (Step A13).

The determining section 41 compares the calculated speed of the vehicle 1 and the threshold value Vth of speed set by the threshold value setting section 42 and determines which of them is more. When the speed of the vehicle 1 is smaller than the threshold value (step A14; YES), the control advances to the processing of step A15. When the speed of the vehicle 1 is equal to or more than the threshold value (Step A14; NO), it is determined that there is a spoofing suspicion (Step A18).

The determining section 41 compares the calculated acceleration of the vehicle 1 and the threshold value Ath of acceleration set by the threshold value setting section 42 and determines which of them is more. When the acceleration of the vehicle 1 is smaller than the threshold value (Step A15; YES), the control advances to the processing of step A16. When the acceleration of the vehicle 1 is equal to or more than the threshold value (Step A15; NO), it is determined that there is a spoofing suspicion (Step A18).

The determining section 41 compares the calculated angular speed of the vehicle 1 and the threshold value Ath of angular speed set by the threshold value setting section 42 and determines which of them is more. When the angular speed of the vehicle 1 is smaller than the threshold value (step A16; YES), the control advances to the processing of step A17. When the acceleration of the vehicle 1 is equal to or more than the threshold value (Step A16; NO), it is determined that there is a spoofing suspicion (Step A18). Through the above processing, it is possible to determine that there is a spoofing suspicion, when a change rate of the direction of the vehicle is unnaturally large.

The processing of steps A14 to A16 may be executed in an optional order and only one or two kinds of processing of the three kinds of processing may be executed. When a quantity showing the movement of the vehicle (speed, acceleration, angular speed) falls below the threshold value in all kinds of processing, the spoofing is determined riot to have been carried out (Step A17).

When it is determined that there is a spoofing suspicion, a record of spoofing suspicion is registered on the spoofing candidacy database 51 in relation to the current time outputted from the GNSS chip 7 at step A18.

When the spoofing suspicion has occurred, the determining section 41 extracts a record of past spoofing suspicion from the spoofing candidacy database 51. When a period for which the spoofing suspicion continues is shorter than a given threshold value (Step A19; NO), it is determined that the spoofing suspicion is caused by a short-range positioning error due to a multipath and so on and the spoofing has not been carried out (Step A17). When the period for which the spoofing suspicion continues is equal to or longer than the given threshold value (Step A19; YES), the spoofing is determined to have been carried out (Step A20).

The determining section 41 outputs the determination result 39 showing the non-existence of spoofing generated in step A17 or the existence of spoofing generated in step A20 (Step A21). The main processing section 34 takes the determination result 39 into consideration when executing the charging processing and so on based on the positioning result 38 outputted from the GNSS chip 7, like the first embodiment.

### (Spoofing Determination Using Start-Up State of Engine)

In addition to the above processing, a spoofing determination by using the operation of an engine data collecting section 43 of FIG. 11 may be added. Generally, the position of the vehicle 1 does not change when an engine of the vehicle 1 is in the stop state. If the position of the vehicle 1 estimated by the satellite positioning system is changed over an extent in the stop state of the engine, it could be considered that there is a spoofing suspicion.

To detect such a spoofing suspicion, the engine data collecting section 43 monitors the ignition ON/OFF signal 19. When the engine of the vehicle 1 is determined to have been stopped (an ignition key is determined to be set to an off state) based on the ignition ON/OFF signal 19, the engine data collecting section 43 stores the last positioning result 36 outputted from the GNSS chip 7 in the storage unit of the on-board unit 2 as the positioning result in the engine stop state.

When recognizing that ignition ON/OFF signal 19 is changed from an OFF state to an ON state, the engine data collecting section 43 transfers the first positioning result 36 outputted from the GNSS chip 7 as the positioning result in the engine start-up state to the determining section 41, together with the positioning result in the engine stop state. The determining section 41 calculates a difference between the positioning result in the engine start state and the positioning result in the engine stop state. The determining section 41 determines to be normal when the difference is smaller than a given threshold value, and determines that the spoofing has been carried out, when the difference is equal to or more than the given threshold value.

### (Operation of Spoofing Detecting Section Using DSRC Time Data)

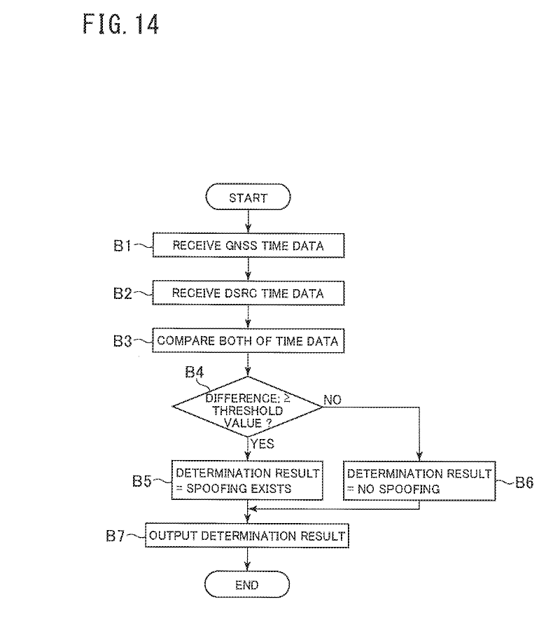

In the present embodiment, the spoofing detecting section 31 carries out the spoofing detection (previously mentioned processing (2)) through the comparison between the GNSS time and the DSRC time. FIG. 14 is a flow chart showing the operation of the spoofing detecting section 31 in case of the spoofing detection based on the comparison between the GNSS time data and the DSRC time data in the present embodiment.

First, when the engine of the vehicle 1 starts so that the on-board unit 2 is turned on, the GNSS chip 7 outputs the GNSS time data 37 showing the current time based on the GNSS satellite information. The realtime clock 33 outputs the GNSS time data 40 corresponding to the GNSS time data 37 to the spoofing detecting section 31 in approximately realtime (Step B1). The time data acquiring section 44 acquires the DSRC time data, from the DSRC communication processing section. 11 in approximately realtime (Step B2).

The determining section 41 compares the GNSS time data 40 and the DSRC time data (Step B3). When the difference between the time shown by the GNSS time data 40 and the time shown by the DSRO time data is smaller than a given threshold value (Step B4; NO), the determining section 41 determines that the spoofing has not been carried out (Step B6). When the difference between the time shown by the GNSS time data 40 and the time shown by the DSRC time data is equal to or more than the given threshold value (Step B4; YES), the determining section 41 determines that the spoofing has been carried out (Step B5).

The determining section 41 outputs the determination result 39 of the existence or non-existence of spoofing (Step B7). The main processing section 34 carries out processing such as the charging processing based on the positioning result 38, taking the determination result 39 into consideration. For example, when the spoofing is determined to have been carried out, the main processing section 34 stops usual charging processing and stores data showing the determination result 39 in the storage unit.

As one of the techniques of the spoofing, it could be considered that the past positioning result by the satellite positioning system is used by spoofing as if to be the current position data of the vehicle. In such a case, there is a possibility that the time data contained in data for the spoofing is different from the current time. Through the processing of the present embodiment, in such a case, the spoofing can be detected by comparing and verifying the time from the satellite positioning system and the time from the roadside system 16.

### (Spoofing Detection Using Cellular Communication Network Time Data)

As a modification example of the spoofing detection shown in FIG. 14, the cellular communication may be used in place of the roadside system 16. In the modification example, the cellular communication network generates cellular communication time data showing the current time. The cellular communication time data is transmitted to the on-board unit 2 from the cellular base station 13. The cellular communication chip 9 transfers the cellular communication time data received through the cellular communication antenna 8 to the spoofing detecting section 31 in approximately realtime.

In the modification example, the spoofing detecting section 31 receives the cellular communication time data in place of the DSRC time data at step B2 of FIG. 14. The other kinds of processing are the same as those in FIG. 14. In such a satellite positioning system, the spoofing can be detected by verifying the reliability of the GNSS time data by using the time supplied from the cellular communication network, even in an area where the DSRC roadside unit is not installed.

1. An on-board unit comprising:
a positioning section configured to output first position data showing a current position of a vehicle based on a positioning signal received from an artificial satellite; and
a processing section configured to acquire a second position data showing a current position of the vehicle based on a radio signal which is different from the positioning signal, and to detect a spoofing based on a position shown by the first position data and a position shown by the second position data.

2. The on-board unit according to claim 1, wherein the processing section is configured to acquire the second position data from a roadside unit which is provided for a side of a road on which the vehicle runs.

3. The on-board unit according to claim 1, further comprising:
a cellular communication section configured to receive identification data for specifying a base station in a cellular communication through the base station,
wherein the processing section is configured to acquire the second position data based on the identification data.

4. The on-board unit according to claim 1, wherein the processing section is configured to determine that the spoofing has been carried out when a difference between a position shown by the first position data and a position shown by the second position data.

5. A spoofing detecting method of an on-board unit, comprising:
outputting first position data showing a current position of a vehicle based on a positioning signal received from an artificial satellite;
acquiring second position data showing a current position of the vehicle by a radio signal which is different from the positioning signal; and
detecting a spoofing based on the position shown by the first position data and the position shown by the second position data.

6. The spoofing detecting method according to claim 5, wherein the second position data is acquired from a roadside unit provided for a roadside of a road on which the vehicle runs.

7. The spoofing detecting method according to claim 5, further comprising:
receiving identification data for specifying a base station, in a cellular communication through the base station,
wherein the acquiring the second position data comprises:
acquiring the second position data based on the identification data.

8. The spoofing detecting method according to claim 5, wherein the detecting the spoofing comprises:
determining that the spoofing has been carried out when a difference between the position shown by the first position data and the position shown by the second position data is equal to or more than a given reference value.
